(19) United States
(12) Patent Application Publication
(10) Pub. No.: US 2013/0092746 A1
(43) Pub. Date: Apr. 18, 2013

(54) ADJUSTABLE MISTING NOZZLE FOR A DISTRIBUTION MANIFOLD

(71) Applicant: PARKER-HANNIFIN CORPORATION, Cleveland, OH (US)

(72) Inventors: Richard E. Scott, Naples, FL (US); William K. Stoll, Bonita Springs, FL (US)

(73) Assignee: PARKER-HANNIFIN CORPORATION, Cleveland, OH (US)

(21) Appl. No.: 13/649,806

(22) Filed: Oct. 11, 2012

Related U.S. Application Data
(60) Provisional application No. 61/546,113, filed on Oct. 12, 2011.

(51) Int. Cl. B05B 7/00

(52) U.S. Cl. 239/1; 239/418; 137/315.01

(57) ABSTRACT

A manifold includes a housing enclosing a mixing chamber, where the housing has multiple ports opening on the mixing chamber, including a carrier gas inlet port, a liquid inlet port, and a mist outlet port. The manifold further includes a spray nozzle coupled to the liquid inlet port. The spray nozzle has an outlet that opens to the interior of the mixing chamber such that liquid exiting the outlet is sprayed into the mixing chamber and can mix with a carrier gas entering the mixing chamber through the carrier gas inlet port to form a mist. The mist can exit the mixing chamber through the mist outlet port. The manifold also includes an adjustable-length flow path between the liquid inlet port and the spray nozzle outlet. The length of the flow path is adjustable to vary the flow rate of liquid sprayed from the spray nozzle outlet.

### RELATED APPLICATIONS

This application claims the benefit of U.S. Provisional Application No. 61/546,113 filed Oct. 12, 2011, which is hereby incorporated herein by reference.

### FIELD OF THE INVENTION

The invention concerns a cooling system for machinery, and in particular to an adjustable spray nozzle for a manifold for distributing a cooling mist.

### BACKGROUND

Machinery often needs to be cooled to remain in an optimal working condition. A cooling fluid typically is distributed to areas of the machinery that require cooling. A manifold is often used to distribute the cooling fluid from a common source to multiple sites.

### SUMMARY OF THE INVENTION

The present invention provides a manifold with multiple ports, including, for example, an inlet port to receive an air flow, an inlet port to receive a liquid flow, and one or more outlet ports to send out a fluid mist flow. The manifold mixes the air inlet flow and the liquid inlet flow in exact proportions, and then sends the mixture of air carrying the liquid as a mist through the outlet ports to several areas of a machine. The misted air serves to both cool and lubricate those areas of the machine. A spray nozzle is used to spray the liquid into the air flow in the manifold to create a mist. The spray nozzle has a flow adjustment feature capable of metering the flow of liquid without using an orifice that would be so small that it would be prone to clogging with debris in the liquid flow. An exemplary liquid is lubricating oil, but other liquids could be used to form the mist with air or another gas.

A benefit of the present invention is that it is more resistant to small dirt particles that would clog ordinary atomization orifices. The lubricant flow is readily adjustable to ensure that the output flow is within the desired limits. Ordinary atomization orifices are not adjustable. The invention is uncomplicated because the invention employs a single flow metering device instead of a multiplicity of flow orifices.

The present invention is contemplated to provide the nozzle body itself; the nozzle body in combination with the bore, e.g., the nozzle body in combination with a base plate for a distribution manifold; as well as the nozzle body, the bore, and the distribution manifold as a single unit.

More particularly, the present invention provides a manifold that includes a housing enclosing a mixing chamber, where the housing has multiple ports opening on the mixing chamber, including a carrier gas inlet port, a liquid inlet port, and a mist outlet port. The manifold further includes a spray nozzle coupled to the liquid inlet port. The spray nozzle has an outlet that opens to the interior of the mixing chamber such that liquid exiting the outlet is sprayed into the mixing chamber and can mix with a carrier gas entering the mixing chamber through the carrier gas inlet port to form a mist. The mist can exit the mixing chamber through the mist outlet port. The manifold also includes an adjustable-length flow path between the liquid inlet port and the spray nozzle outlet. The length of the flow path is adjustable to vary the flow rate of liquid sprayed from the spray nozzle outlet.

To accomplish the variable length of the flow path, the flow path can have a helical shape defined by cooperating structure that includes a first member with external threads and a second member with internal threads.

The present invention also provides a misting device that includes a nozzle body supported within a cavity in a nozzle housing. The nozzle body includes a spray orifice at a proximal end thereof. The nozzle body and the nozzle housing have cooperating structures that define a helical flow path fluidly connected to a liquid inlet port and the spray orifice.

Preferably, the nozzle body is moveable relative to the nozzle housing along a longitudinal axis to change the length of the helical flow path. More preferably, the nozzle body is threadably connected to the nozzle housing to enable the nozzle body to be screwed into and out of the nozzle housing.

Optionally, the nozzle body includes i) a slot along the periphery of the nozzle body from a distal end that fluidly interconnects the helical flow path with an area of the nozzle housing between an end wall of the cylindrical bore and the distal end of the nozzle body; and ii) a passage fluidly interconnecting the distal end of the nozzle body and the spray orifice.

Preferably, the spray orifice has a cross-sectional area that is larger than the cross-sectional area of the helical flow path.

The present invention further provides a method for adjusting the flow rate through a spray nozzle, that includes the step of adjusting the length of a flow path by rotating a threaded adjustment plug in a threaded bore.

Additionally, the present invention provides a misting device with a metering flow path for controlling a flow rate of liquid to an outlet orifice, the flow path being variable in length to vary the flow rate.

The present invention also provides a device that includes a housing defining an enclosed volume. The housing has multiple openings therethrough in communication with the enclosed volume. And the device further includes a passage having an orifice opening on the enclosed volume, where the length of the passage can be selectively varied.

In addition, the present invention provides a body that is threadably insertable into a threaded cavity. The body defines a generally cylindrical volume having a first end and a second end and a longitudinal axis extending between the first end and the second end. The body also has an outer surface with threads that are proud of the surface, where an outer surface of the thread defines a surface with each point on the surface being equidistant from the longitudinal axis of the cylindrical volume. The body further has a passage within the cylindrical volume that extends from the first end to the second end. At least one end of the passage has a major dimension of no less than about thirty thousandths of an inch (about eight hundredths of a centimeter).

The present invention further thus provides a manifold that includes both i) a chamber having a fluid inlet port, an air inlet port, and one or more fluid/air outlet ports; and ii) a misting device including a nozzle adjustably supported within a misting body. The nozzle includes a spray orifice, and the nozzle and the misting body have cooperating structure defining a helical flow path fluidly connecting the fluid inlet port and the spray orifice. The nozzle is moveable relative to the misting body to change the length of the helical flow path.

In one embodiment, the movable nozzle includes a cylindrical body with external threads, and the misting body includes a cylindrical chamber with internal threads for receiving the threads of the nozzle body. The nozzle body includes i) a slot along the periphery of the nozzle body toward an inner distal end fluidly interconnecting the helical flow path with an area of the cylindrical body chamber between an end wall of the cylindrical body chamber and the inner distal end of the nozzle body; and ii) a central passageway along the length of the nozzle body fluidly interconnecting the inner distal end of the nozzle body and the spray orifice.

### BRIEF DESCRIPTION OF THE DRAWINGS

FIG. 1 is a schematic illustration of an adjustable mist-distribution manifold provided in accordance with the present invention.

FIG. 2 is a perspective view, partially away, of an exemplary embodiment of the mist-distribution manifold provided in accordance with the present invention.

FIG. 3 is a plan view of base portion of the mist-distribution manifold of FIG. 2.

FIG. 4 is a cross-sectional view of the base portion of the mist-distribution manifold of FIG. 3 as seen on lines 4-4.

FIG. 5 is a cross-sectional view of a spray nozzle portion of the base of the mist-distribution manifold of FIG. 3, as seen along section lines 5-5.

FIG. 6 is an enlarged view of a portion of the spray nozzle of FIG. 5, as indicated at section 6.

FIG. 7 is a side view of a spray nozzle body for use in the adjustable mist-distribution manifold in accordance with the present invention.

FIG. 8 is an end view of the nozzle body of FIG. 7.

FIG. 9 is a cross-sectional view of the nozzle body of FIG. 8 as seen along section lines 9-9.

FIG. 10 is an enlarged view of a thread portion of the nozzle body of FIG. 7 as indicated at section 10.

FIG. 11 is an enlarged view of a portion of the nozzle body as indicated at section 11 of FIG. 9.

### DETAILED DESCRIPTION

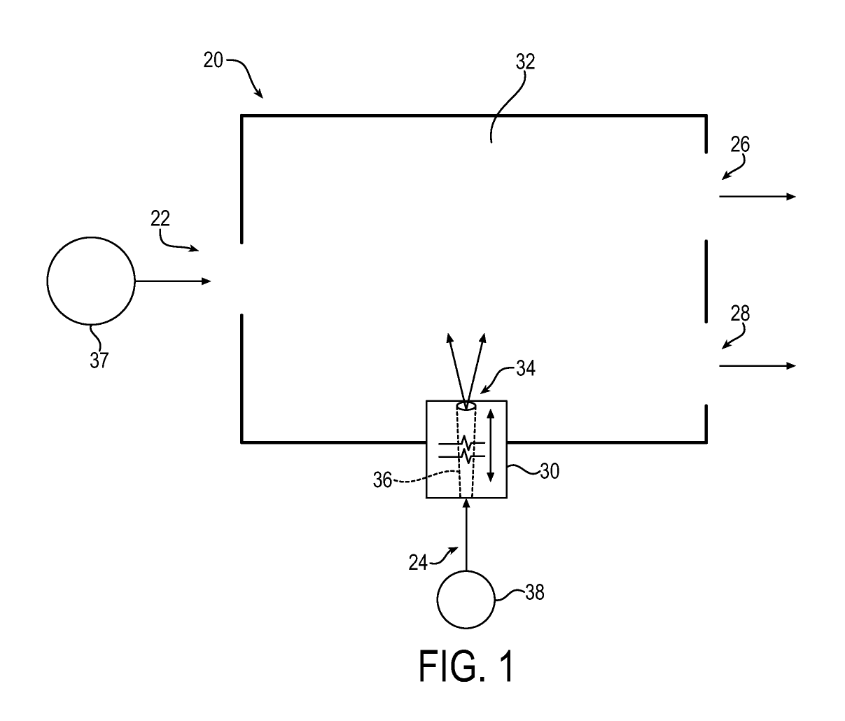

Referring now to the drawings, an initially to FIG. 1, the present invention provides a manifold 20 with multiple ports, including, for example, a gas inlet port 22 to receive a carrier gas flow, such as air; a liquid inlet port 24 to receive a liquid flow, such as an oil; and one or more outlet ports to receive a fluid mist flow. Two outlet ports 26 and 28 are illustrated in FIG. 1. The manifold 20 mixes the air inlet flow and the liquid inlet flow in exact proportions, and then sends the mixture of air carrying the liquid as a mist through the outlet ports 26 and 28 to several areas of a machine. The misted air mixture serves to both cool and lubricate those areas of the machine. A spray nozzle 30 is used to spray the liquid into the air flow in the manifold 20 to create the mist. The spray nozzle 30 is coupled to the liquid input port 24. The spray nozzle 30 has a flow adjustment feature capable of metering the flow of liquid without using an orifice that would be so small that it would be prone to clogging with debris in the liquid flow. An exemplary liquid is a lubricating oil, but other liquids could be used to form the mist with air or another gas.

The manifold 20 includes a mixing chamber 32 for mixing the gas entering the manifold 20 through the gas inlet port 22 and a liquid from the liquid inlet port 24 sprayed from the nozzle 30. The spray nozzle 30 has an outlet 34 that opens to the interior of the mixing chamber 32 such that liquid exiting the outlet 34 is sprayed for mixing with the air or other carrier gas from the carrier gas inlet port 22 to form the mist mixture. The mist exits the mixing chamber 32 via the outlet ports 26 and 28. The spray nozzle 30 has an adjustable length flow path between the liquid inlet port 24 and the spray nozzle outlet 34. The length of the flow path 36 is adjustable to vary the flow rate of liquid that can be sprayed from the spray nozzle outlet 34.

A system including the manifold 40 can further include a supply of gas 37, such as air, coupled to the carrier gas inlet port 22; and a supply of liquid 38, such as a lubricating oil, coupled to the liquid inlet port 24.

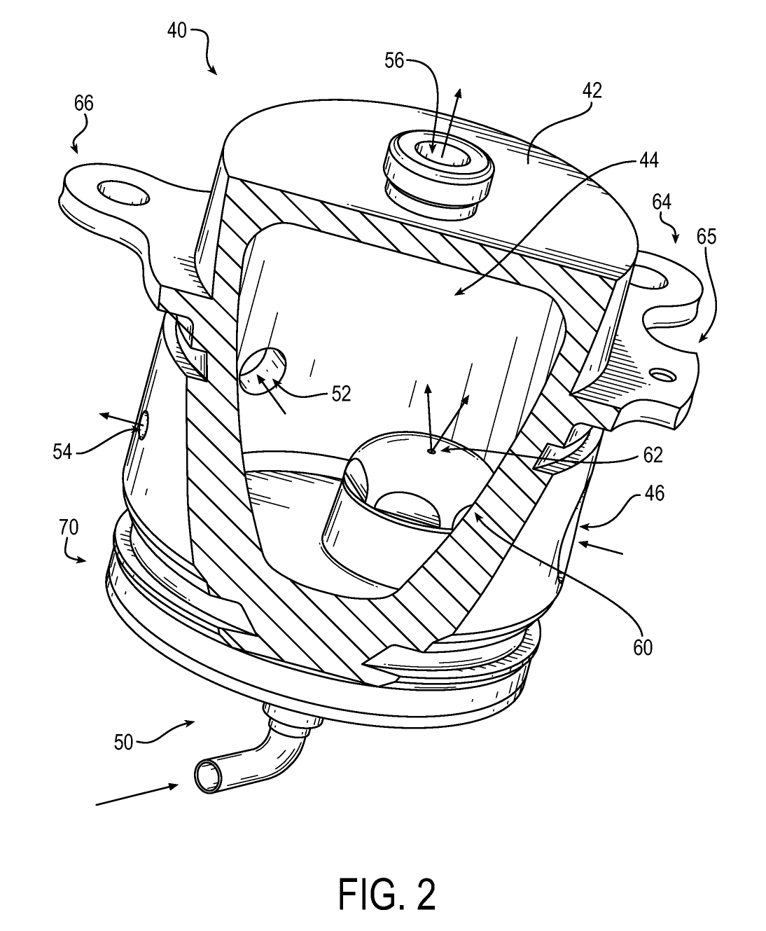

FIG. 2 illustrates an exemplary manifold 40 for distributing a mist, such as an air-oil mist for cooling and lubricating purposes. The manifold 40 includes a housing 42, which defines an enclosed volume of a mixing chamber 44. The housing 42 has multiple openings therethrough in communication with the enclosed volume of the mixing chamber 44, including a carrier gas inlet port 46, a liquid inlet port 50, and a mist outlet port. In this embodiment, the manifold 40 includes multiple mist outlet ports, and three outlet ports 52, 54, and 56 are shown exiting in separate directions from the manifold 40.

A spray nozzle 60 is coupled to the liquid inlet port 50. The spray nozzle 60 has an outlet orifice 62 that opens to the interior of the mixing chamber 44 such that liquid exiting the outlet 62 is sprayed into the air or other carrier gas entering the mixing chamber 44 via the carrier gas inlet port 46. The air and sprayed liquid mix to form a mixture in the form of a mist. The speed of the carrier gas, such as air, through the manifold 40 helps to create the mist as the liquid is sprayed from the outlet 62 of the spray nozzle 60.

The sprayed liquid is suspended in the air flow, and the resulting mist flow exits the mixing chamber 44 via the outlet ports 52, 54, and 56. An exemplary application for such a manifold 40 is in a helicopter. The air flow with the entrained liquid lubricant mist is divided among the several mist output ports 52, 54, and 56, which can be connected with distribution conduits (not shown) for distribution to respective remote areas of a machine that need to be cooled and lubricated. The illustrated manifold 40 also includes several mounting brackets 64, 65, and 66 for mounting the manifold 40 on a support structure (not shown).

The spray nozzle 60 provides an adjustable-length flow path between the liquid inlet port 50 and the spray nozzle outlet orifice 62, in a manner described in further detail in the following paragraphs. The length of the flow path is adjustable to vary the flow rate of liquid that can be sprayed from the spray nozzle outlet 62.

The spray nozzle 60 is mounted to the housing 42. The housing 42 shown in FIG. 2 has a detachable base 70 that closes a bottom side of the housing 42. Alternatively, the base 70 may be formed integrally with the rest of the housing 42 as a single unit.

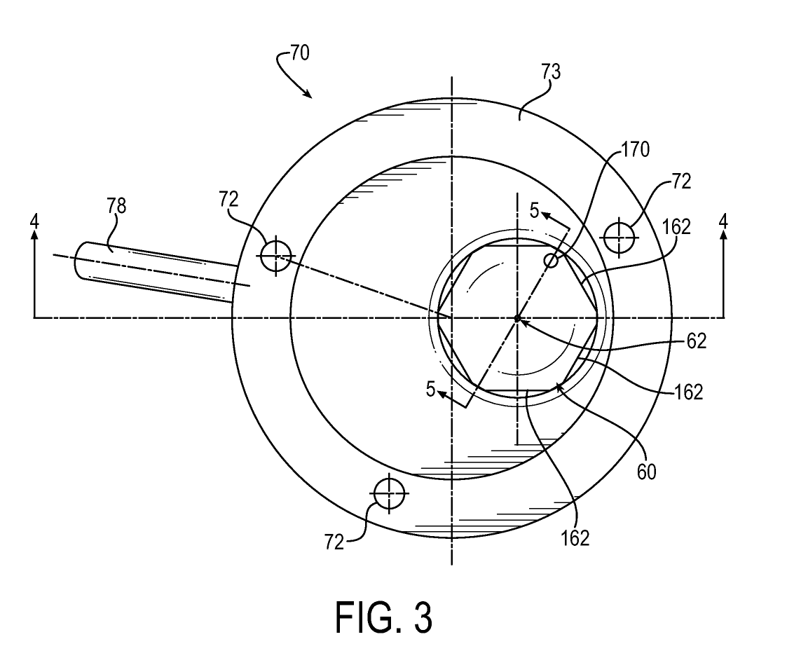

A top view of the base 70 with the mounted spray nozzle 60 is shown in FIG. 3. This is the side of the base 70 that faces the mixing chamber 44 (FIG. 2). The illustrated base 70includes means for fastening the base to the rest of the housing 42 (FIG. 2), such as the illustrated holes 72 equally circumferentially-spaced along an outer perimeter of the base 70 for receipt of fasteners (not shown) therein.

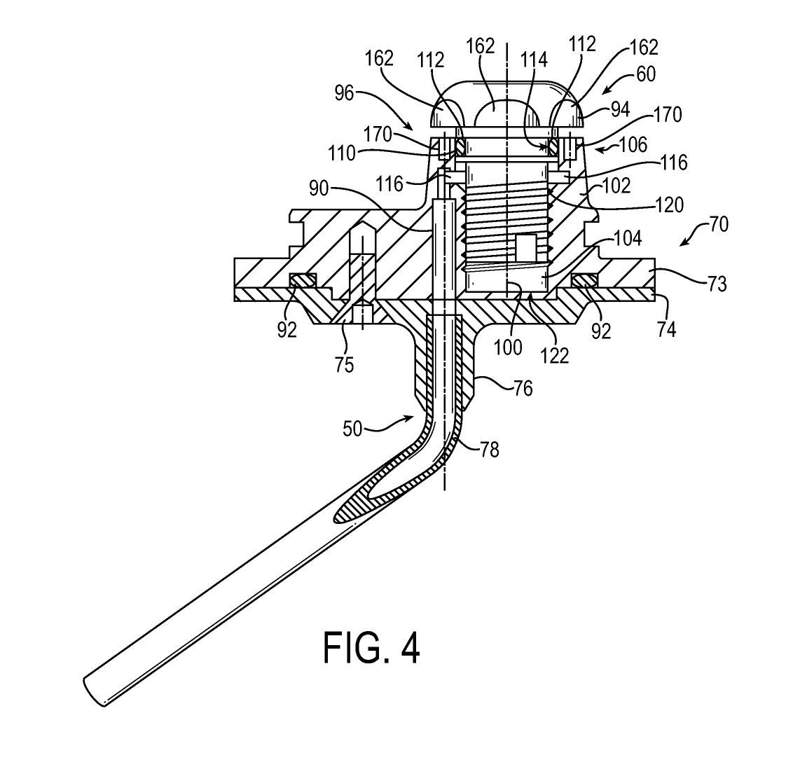

As shown in FIGS. 3 and 4, the base 70 includes multiple parts, a base plate 73 and a sub-base 74 secured to the base plate 73 with one or more fasteners 75. The liquid inlet port 50 is formed in the base 70. The sub-base 74 includes a nipple 76 or other connection for receipt of a liquid-carrying conduit or tube 78 for delivering liquid to the spray nozzle 60. The liquid tube 78 connects to an inlet passage 90 aligned with the nipple connection 76 for receipt of liquid from the tube 78. A seal 92 is provided between the base plate 73 and the sub-base 74 to prevent the leakage of liquid from between the base 73 and the sub-base 74. This two-part construction of the base 70 may facilitate manufacture of the liquid passages, but the base plate 73 and the sub-base 74 could be combined in a single structure.

In the illustrated embodiment, the liquid inlet port 50 is formed in the base 70, and the spray nozzle 60 is mounted to the base 70. More particularly, the spray nozzle 60 includes a nozzle body 94 that is mounted in a particular structure on the base 70 that acts as a nozzle housing 96 for receipt of the nozzle body 94. The nozzle body 94 is moveable relative to the nozzle housing 96 along a longitudinal axis 100 to change the length of the flow path. The illustrated base plate 73 is generally planar, with a protrusion 102 extending therefrom. A bore 104 formed in the protrusion 102 receives the nozzle body 94, and the nozzle body 94 and the base 70 cooperate to define a liquid flow path therebetween. The liquid inlet passage 90 is coupled to the bore 104 in the base 70. The bore 104 is generally cylindrical, and the bore 104 is adapted for receipt of the generally-cylindrical nozzle body 94 therein. The base 70 thus acts as the nozzle housing 96 with a cavity 104 for receipt of a nozzle body 94.

Returning to the base 70, and specifically the bore 104, a proximal end 106 of the bore 104 includes a generally smooth, constant-diameter sealing surface 110. A seal 112, such as an o-ring, mounted in a groove 114 on the spray nozzle body 94 rides against the sealing surface 110 in the bore 104 to seal the liquid therein and prevent liquid leakage from between the nozzle body 94 and the sides of the bore 104.

Distally adjacent the sealing surface 110, the bore 104 includes an enlarged annular inlet chamber 116 for receipt of liquid from the inlet passage 90. The annular inlet chamber 116 has a diameter that is larger than the diameter of the bore 104, and allows liquid to flow completely around the circumference of the bore 104 and the nozzle body 94 therein. Distally adjacent the annular inlet chamber 116, the bore 104 has a reduced diameter that is less than the diameter of the inlet chamber 116. In the illustrated embodiment, the diameter of the bore 104 distally adjacent the annular inlet chamber 116 also less than the diameter of the bore 104 at the sealing surface 110. This distal portion of the bore 104 includes internally-formed threads 120 in a helical pattern in the wall of the bore 104. These threads 120 have a generally triangular cross-section and stop short of the distal end or bottom 122 of the bore 104. The cooperating structure of the nozzle body 94 and the bore 104 in the base 70 define the helical flow path fluidly connecting the liquid inlet port 50 and the spray orifice 62 in the spray nozzle 60.

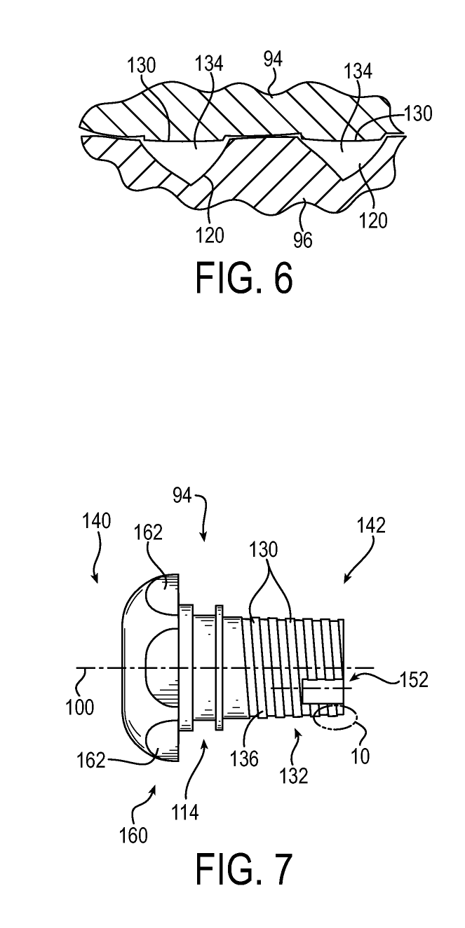

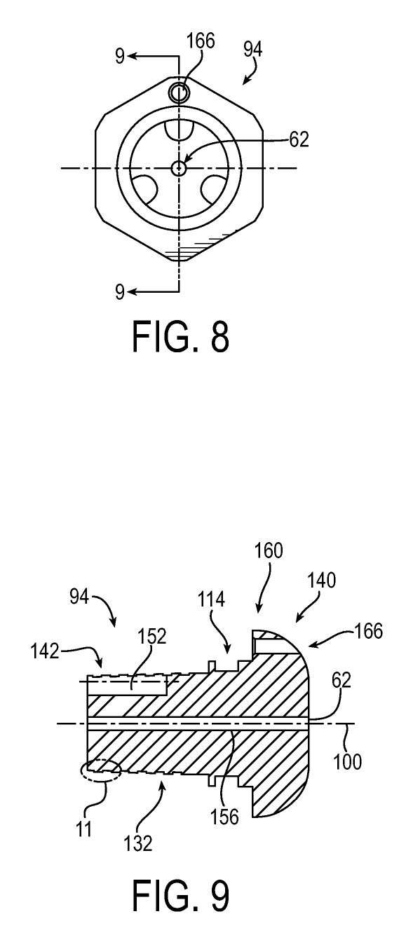

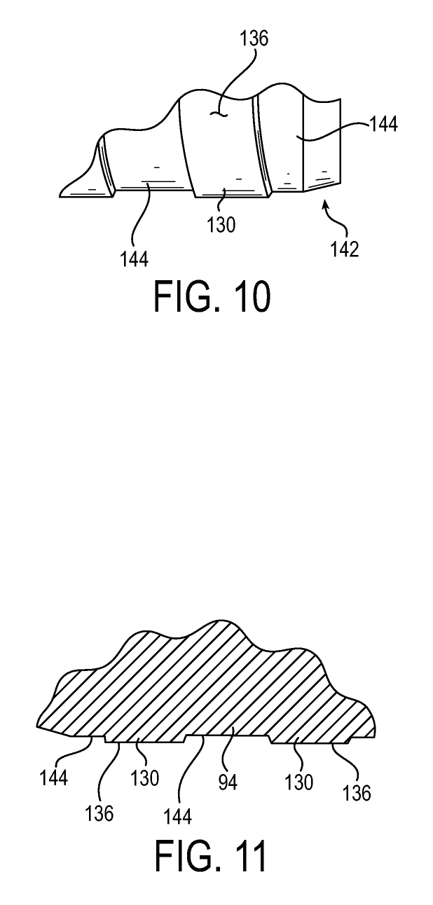

The nozzle body 94 provided by the present invention will now be described with reference to FIGS. 4 through 11. The nozzle body 94 has corresponding external threads 130 on a distal portion thereof for receipt in the threads 120 formed on the inner surfaces of the bore 104. The cooperating threads 130 and 120 of the nozzle body 94 and the bore 104, respectively, enable the nozzle body 94 to be screwed into and out of the bore 104, the structure around the bore 104 functioning as the nozzle housing 96, and it is this movement of the nozzle body 94 relative to the nozzle housing 96 that changes the length of the flow path.

The external threads 130 on the nozzle body 94 have a flattened profile that contrasts with the triangular cross-sectional profile of the threads 120 formed in the side wall of the bore 104. Consequently, a relatively large gap is formed between the external threads 130 of the nozzle body 94 and the internal threads 120 of the bore 104, creating a helical passage 134 therethrough that has a generally triangular cross-section. The threads 130 on the nozzle body 94 also can be described as having an outer surface 136 that lies on a cylinder that is concentric with the axis 100 of the generally cylindrical volume of the nozzle body 94.

Alternatively, the nozzle body 94 can be interpreted to define a generally cylindrical volume having a first (proximal) end 140 and a second (distal) end 142 with the longitudinal axis 100 extending between the first end 140 and the second end 142. The body 94 also has an outer surface 144, and threads 130 that are proud of the surface 144, where an outer surface 146 of the threads 130 defines a surface 146 where each point on the surface 146 is equidistant from the longitudinal axis 100 of the cylindrical volume defined by the nozzle body 94.

Although the passage 134 in the flow path is shown as having a triangular cross-section, other cross-sectional shapes are possible. The external threads 130 on the nozzle body 94 are approximately three-thousandths of an inch (about eight hundredths of a millimeter) proud of the surface 144 of the generally cylindrical nozzle body 94.

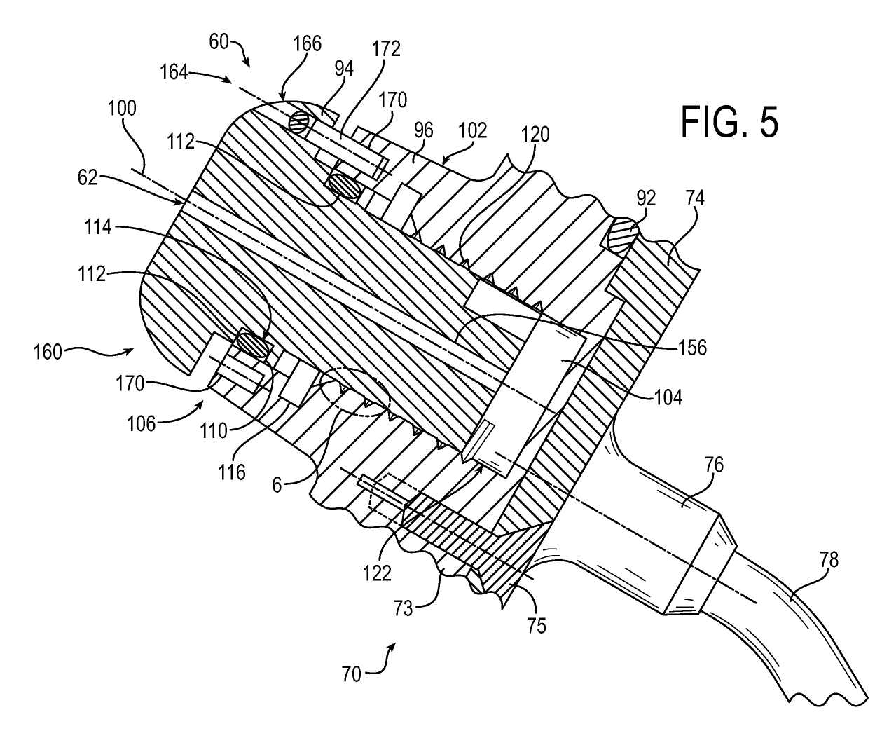

The threads 120 in the side wall of the bore 104 extend from the annular inlet chamber 116 and can extend beyond the distal end 142 of the nozzle body 104, as shown in FIG. 5, to provide a continuous helical passage 134 from the annular inlet chamber 116 to an accumulation chamber 150 formed between the distal end 142 of the nozzle body 104 and the distal end 122 of the bore 104. The length of this helical passage 134 is selectively varied or adjusted by rotating the nozzle body 94 within the bore 104 to vary the length of the helical passage between the annular inlet chamber 116 and the accumulation chamber 150.

The helical passage 134 can be cut short, or short-circuited, by one or more slots or notches 152 formed in the outer surface of the nozzle body 94. The notches 152 extend from a distal end 142 of the nozzle body 94 longitudinally across at least one thread 130. These slots or notches 152 generally extend parallel to the longitudinal axis 100 of the nozzle body 94 and interrupt the external threads 130 on the nozzle body 94 at least once. Multiple notches 152 can be provided, circumferentially spaced around the nozzle body 94. By varying the length of these notches 152 from the distal end 142 of the nozzle body 94, a common nozzle body 94 can be used in a plurality of applications that require different ranges of lengths of flow passages.

These notches 152 also allow the nozzle body 94 to have sufficient contact over its length with the bore 104, regardless of how long the notches 152 are. This also allows the same nozzle body 94 to be used in multiple applications, where the range of lengths, particularly shorter lengths, are desired. A longer nozzle body 94 is more stable for a given diameter. The longer threads 130, even when severed by the notches 152, provide a structural or mechanical advantage for shorter path lengths.

The nozzle body 94 also includes a spray passage 156 extending from the distal end 142 of the nozzle body 94 to the proximal end 140 of the nozzle body 94, typically along or parallel to the longitudinal axis 100 of the nozzle body 94. The diameter of this spray passage 156 can be constant or can be larger at the outlet orifice 62, as shown in FIG. 5. In FIG. 5 the diameter of the spray passage 156 is substantially constant before reaching the spray outlet 62; however, the diameter also could be increased in multiple steps or gradually throughout the entire length of the spray passage 156. The spray passage 156 thus fluidly interconnects the distal end 142 of the nozzle body 94 and the spray orifice outlet 62 at the proximal end 140 of the nozzle body 94.

The spray outlet orifice 62 of the nozzle body 94 has a cross-sectional area that is greater than the cross-sectional area of the helical passage 134. Thus it is the helical passage 134 portion of the flow path that provides the restriction in flow, and controlling the length of that flow path is what controls the flow rate. The misting passage 134 formed between the threads 120 and 130 is a capillary passageway, and in an exemplary embodiment this passage 134 has a major cross-sectional dimension of approximately thirty-thousandths of an inch (about three-quarters of a millimeter) that may be as much as three inches (about eighty millimeters) long. Thus the cooperating structure of the nozzle body 94 and the bore 104 provide a potentially relatively long but very narrow flow path through the passage 134 thus defined. A pressure drop occurs across the length of the passage. Changing the length of the flow path changes the pressure drop and meters the flow rate.

The spray nozzle 60, with its helical flow passage 134 that is adjustable in length, can meter small liquid flows using a large cross-sectional area compared to the cross-sectional areas of other devices for metering liquid flow. The long length of the passage 134 produces laminar flow. With laminar flow, the flow rate of lubricant through the helical passage 134 depends inversely on the length of the passage 134. The length of the helical passage 134 can be increased or decreased by rotating the spray nozzle 60, thereby moving the nozzle body 94 along the longitudinal axis 100 relative to the base 70 or other nozzle housing 96, and thus decreasing or increasing the flow rate of the lubricant. Laminar flow also allows the internal cross-sectional dimensions of the passage 134 to be substantially larger than the diameter of an orifice having an equivalent flow resistance. The larger dimensions of the laminar flow feature provide the ability to avoid clogging by contaminant particles that would clog an equivalent orifice.

A proximal end 140 of the nozzle body 94 has an enlarged head portion 160 with a diameter that is larger than the thread diameter, the diameter of the threaded portion 132of the nozzle body 94, including the threads 130, which is larger than the diameter of the bore 94. This enlarged head portion 160 limits the extent to which the nozzle body 94 can be advanced toward the distal end 12 2 of the bore 94. The circumferential surface of the head portion 160 may be formed with flats 162 or other surface treatments to facilitate engaging and rotating the nozzle body 94 within the bore 104.

The enlarged head portion 160 also includes means for locking the nozzle body 94 in place relative to the base 70. The locking means can include a device 164 for fixing the nozzle body 94 in place. In the illustrated embodiment, the locking device 164 includes a lock passage 166 parallel to the longitudinal axis 100, radially-displaced toward a peripheral portion of the head portion 160. A multitude of locking holes 170 in the base 70, circumferentially spaced around the bore 104 can align with the radially-outward locking passage 166. Once the nozzle body 94 is rotated to a desired position to provide the desired length of flow passage and thereby obtain a desired flow rate, a fastener or locating pin 172 can be inserted through this passage 166 and advanced to also engage one of the plurality of corresponding holes 170 in the base 70 for fixing the nozzle body 94 in the desired position.

The present invention thus provides a metering flow path for controlling the flow rate of liquid to a nozzle 60. The liquid flow path has a variable length, whereby varying the length of the flow path varies the flow rate. In particular, the present invention provides a helical flow path between a first member (such as the base 70) with internal threads 120 and a second member (such as the nozzle body 94) with external threads 130. The shapes of the corresponding threads 120 and 130 cooperate to define the helical passage 134 on the flow path.

In operation, the lubricant enters the manifold 40 via the liquid inlet port 50 through an external tube 78, and travels through an internal passage 90 to the annular chamber 116 at the beginning of the helical passage 134 with the triangular cross-section. The lubricant then flows along the helical passage 134 until it reaches the notch 152 in the nozzle body 94. The effective length of the helical passage 134 can be varied by rotating the nozzle body 94, changing the distance that the lubricant flow travels in the passage 134 before reaching the notch 152. Changing the distance travelled changes the lubricant flow rate. The lubricant flows though the notch 152 into the accumulation chamber 150 underneath the nozzle body 94. The lubricant then flows into an opening in the distal end 142 of the nozzle body 94, and is expelled out of the outlet 62 at the top or proximal end 140 of the nozzle body 94 and into the mixing chamber 44.

In the mixing chamber 44, the lubricant flow meets the entering air flow and is mixed thoroughly with the air, becoming a mist entrained in the air. The mixture of air and oil mist then leaves the mixing chamber 44 in the manifold 40 through the multiple outlet ports 52, 54, and 56. The rate of fluid flow is adjusted by rotating the nozzle body 94 relative to the nozzle housing 96 portion of the base 70.

Accordingly, the present invention thus also provides a method for adjusting the flow rate through a spray nozzle 60, comprising the step of adjusting the length of a flow path by rotating a threaded adjustment plug (such as the nozzle body 94) in a threaded bore 104.

In summary, the present invention provides a manifold 40 that includes a housing 42 enclosing a mixing chamber 44. The housing 42 has multiple ports opening on the mixing chamber 44, including a carrier gas inlet port 46, a liquid inlet port 50, and a mist outlet port 52, 54, or 56. The manifold 40 further includes a spray nozzle 60 coupled to the liquid inlet port 50. The spray nozzle 60 has an outlet 62 that opens to the interior of the mixing chamber 44 such that liquid exiting the outlet 62 is sprayed into the mixing chamber 44 and can mix with a carrier gas entering the mixing chamber 44 through the carrier gas inlet port 46 to form a mist. The mist can exit the mixing chamber 44 through the mist outlet port 52, 54, or 56. The manifold 40 also includes an adjustable-length flow path between the liquid inlet port 50 and the spray nozzle outlet 62. The length of the flow path is adjustable to vary the flow rate of liquid sprayed from the spray nozzle outlet 62. The nozzle 60 then can be securely fixed in a relatively rotated position that provides the desired flow rate.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A manifold, comprising
a housing enclosing a mixing chamber, the housing having multiple ports opening on the mixing chamber, including a carrier gas inlet port, a liquid inlet port, and a mist outlet port; and
a spray nozzle coupled to the liquid inlet port, the spray nozzle having an outlet that opens to the interior of the mixing chamber such that liquid exiting the outlet is sprayed into the mixing chamber and can mix with a carrier gas entering the mixing chamber through the carrier gas inlet port to form a mist that can exit the mixing chamber through the mist outlet port; and
an adjustable-length flow path between the liquid inlet port and the spray nozzle outlet, the length of the flow path being adjustable to vary the flow rate of liquid sprayed from the spray nozzle outlet.

2. A manifold as set forth in claim 1, where the flow path has a helical shape defined by cooperating structure that includes a first member with external threads and a second member with internal threads.

3. A manifold as set forth in claim 1, where the flow path has a triangular cross-section.

4. A manifold as set forth in claim 1, where the spray nozzle is adjustably supported in the mixing chamber.

5. A manifold as set forth in claim 1, where the mixing chamber includes multiple outlet ports.

6. A system comprising a manifold as set forth in claim 1, a supply of gas coupled to the carrier gas inlet port, and a supply of liquid coupled to the liquid inlet port.

7. A system as set forth in claim 6, where the gas supply includes air and the liquid supply includes oil.

8. A misting device, comprising a nozzle body supported within a cavity in a nozzle housing, the nozzle body including a spray orifice at a proximal end thereof, the nozzle body and the nozzle housing having cooperating structures that define a helical flow path fluidly connected to a liquid inlet port and the spray orifice.

9. A misting device as set forth in claim 8, where the nozzle body has a generally cylindrical shape, and the nozzle body is received in a generally cylindrical bore in the nozzle housing.

10. A misting device as set forth in claim 8, where the spray orifice has a cross-sectional area that is less than the cross-sectional area of the helical flow path.

11. A misting device as set forth in claim 8, where the nozzle body is moveable relative to the nozzle housing along a longitudinal axis to change the length of the helical flow path.

12. A misting device as set forth in claim 8, where the nozzle body is threadably connected to the nozzle housing to enable the nozzle body to be screwed into and out of the nozzle housing.

13. A misting device as set forth in claim 8, where the nozzle body has a cylindrical portion with external threads and the nozzle housing has a cylindrical bore with internal threads, and the nozzle body and the nozzle housing cooperate to define the helical flow path within the internal threads of the nozzle housing.

14. A misting device as set forth in claim 8, where the spray nozzle has a passage that fluidly interconnects a distal end of the nozzle body and the spray orifice.

15. A misting device as set forth in claim 8, where a proximal end of the nozzle body has a cross-sectional dimension that is greater than a thread diameter.

16. A misting device as set forth in claim 8, where the nozzle body includes i) a slot along the periphery of the nozzle body from a distal end that fluidly interconnects the helical flow path with an area of the nozzle housing between an end wall of the cylindrical bore and the distal end of the nozzle body; and ii) a passage fluidly interconnecting the distal end of the nozzle body and the spray orifice.

17. A misting device as set forth in claim 8, where a proximal portion of the nozzle body has a dimension that is greater than a corresponding dimension of the cylindrical cavity in the nozzle housing that receives the nozzle body to limit the distance the nozzle body can advance into the housing.

18. A manifold, comprising:
i) a chamber having multiple ports; and
ii) the misting nozzle as set forth in claim 8.

19. A misting device as set forth in claim 8, where the multiple ports include a liquid inlet port, a gas inlet port, and one or more outlet ports.

20. A misting device as set forth in claim 8, where the nozzle body includes a slot that extends across and interrupts the external threads on the nozzle body at least once.

21. A misting device as set forth in claim 8, where the nozzle body and the nozzle housing cooperate to define an annular chamber surrounding a portion of the nozzle body, and the nozzle housing has a fluid passage fluidly interconnecting the port and the annular chamber.

22. A misting device as set forth in claim 8, where the flow path has a major cross-sectional dimension that is greater than a major cross-sectional dimension of the outlet orifice.

23. A method for adjusting the flow rate through a spray nozzle, comprising the step of adjusting the length of a flow path by rotating a threaded adjustment plug in a threaded bore.

24. A misting device with a metering flow path for controlling a flow rate of liquid to an outlet orifice, the flow path being variable in length to vary the flow rate.

25. A device comprising
a housing defining an enclosed volume, the housing having multiple openings therethrough in communication with the enclosed volume, and a passage having an orifice opening on the enclosed volume, the length of the passage being selectively varied.

26. A body that is threadably insertable into a threaded cavity, the body defining a generally cylindrical volume having a first end and a second end and a longitudinal axis extending between the first end and the second end, the body having an outer surface with threads that are proud of the surface, an outer surface of the thread defining a surface with each point on the surface being equidistant from the longitudinal axis of the cylindrical volume, and the body further has a passage within the cylindrical volume that extends from the first end to the second end, at least one end of the passage having a major dimension of no more than about thirty thousandths of an inch (about eight hundredths of a centimeter).
